(19) United States
(12) Patent Application Publication
(10) Pub. No.: US 2015/0079305 A1
(43) Pub. Date: Mar. 19, 2015

(54) MANUFACTURING METHOD AND MANUFACTURING APPARATUS FOR PRINTING MAGNETIC ORIENTATION MASTER AND MAGNETIC PIGMENT PRESSWORK

(71) Applicant: HUIZHOU FORYOU OPTICAL TECHNOLOGY CO., LTD., Huizhou City, Guangdong Province (CN)

(72) Inventors: Xing Wang, Huizhou City (CN); Yumin Liao, Huizhou City (CN); Qian Huang, Huizhou City (CN); Yifeng Yang, Huizhou City (CN); Pu Wang, Huizhou City (CN)

(21) Appl. No.: 14/394,099

(22) PCT Filed: Apr. 8, 2013
(86) PCT No.: PCT/CN2013/073858

§ 371 Date: Oct. 12, 2014

(30) Foreign Application Priority Data
Apr. 11, 2012 (CN) 201210105940.8

(51) Int. Cl. B05D 3/00; H01F 13/00; B41C 1/055

(52) U.S. Cl. CPC B05D 3/207; B41C 1/055; H01F 13/00
USPC 427/547; 148/121; 148/108; 118/640

(57) ABSTRACT

A manufacturing method and a manufacturing apparatus for a printing magnetic orientation master and a magnetic pigment presswork are provided. The manufacturing method for a printing magnetic orientation master comprises: providing a magnet; using a heat radiation beam to heat a partial area of the magnet so that a new magnetic domain structure is formed in the partial area through self-magnetization of the magnet to change a magnetic-field distribution in the partial area; and removing the heat radiation beam to keep the new magnetic domain structure after it is decreased to a normal temperature so that the changed magnetic-field distribution is kept in the partial area, thus forming the printing magnetic orientation master having a predetermined magnetic orientation pattern. This can simplify the manufacturing process of the printing magnetic orientation master and allow the printing magnetic orientation master to carry abundant pattern information.

### FIELD OF THE INVENTION

The present disclosure relates to the technical field of magnetic orientation printing, and more particularly, to a manufacturing method and a manufacturing apparatus for a printing magnetic orientation master and a magnetic pigment presswork.

### BACKGROUND OF THE INVENTION

Currently, in the field of anti-counterfeit technologies such as paper money or notes printing, a printing magnetic orientation master is usually used to magnetically orientate magnetic pigment flakes in a magnetic optical-variable ink. The printing magnetic orientation master presents particular magnetic fields that are deliberately designed, so that the magnetic pigment flakes can produce a designed unique patterning effect in a presswork.

A conventional printing magnetic orientation master is generally manufactured by etching a surface of a magnet or by combining different magnets. The printing magnetic orientation master manufactured by the conventional technology has an uneven surface and is difficult to process, and is liable to wear and tear which would reduce the service life of the master. In addition, the magnetic orientation pattern of the printing magnetic orientation master manufactured by the etching process is not allowed to be rewritten once being formed, so it cannot be reused; and the processing loss thereof is great, which tends to cause waste of permanent-magnetic rare-earth materials.

Accordingly, it needs to provide a new manufacturing method and a new manufacturing apparatus for a printing magnetic orientation master and a magnetic pigment presswork to solve the aforesaid technical problems.

### SUMMARY OF THE INVENTION

A primary object of the present disclosure is to provide a manufacturing method and a manufacturing apparatus for a printing magnetic orientation master and a magnetic pigment presswork, which can simplify the manufacturing process of the printing magnetic orientation master, reduce the processing loss, save the use of magnetic materials and prolong the service life of the printing magnetic orientation master.

To solve the aforesaid technical problem, a technical solution adopted in the present disclosure is to provide a manufacturing method for a printing magnetic orientation master, which comprises: providing a magnet; using a heat radiation beam to heat a partial area of the magnet so that a new magnetic domain structure is formed in the partial area through self-magnetization of the magnet to change a magnetic-field distribution in the partial area; and removing the heat radiation beam to keep the new magnetic domain structure after it is decreased to a normal temperature so that the changed magnetic-field distribution is kept in the partial area, thus forming the printing magnetic orientation master having a predetermined magnetic orientation pattern.

The manufacturing method further comprises: using a magnetic field to erase the predetermined magnetic orientation pattern of the printing magnetic orientation master to make the printing magnetic orientation master repeatedly rewritable.

The magnetic field is generated through electromagnetic induction or by a permanent magnet.

The step of providing a magnet comprises: using a magnetic field to magnetize a magnetizable material layer along a magnetization direction so as to form the magnet.

The heat radiation beam is a laser beam, an infrared heat radiation beam or an ultrasonic heat radiation beam.

The partial area is heated by the heat radiation beam to a temperature lower than the Curie temperature of the magnet.

The magnet has a planar surface or a cambered surface.

The printing magnetic orientation master has a smooth surface.

To solve the aforesaid technical problem, the present disclosure also provides a manufacturing apparatus for a magnetic pigment presswork, which comprises: a magnetic orientation device, comprising a printing magnetic orientation master, wherein the printing magnetic orientation master is manufactured by a following method: providing a magnet; using a heat radiation beam to heat a partial area of the magnet so that a new magnetic domain structure is formed in the partial area through self-magnetization of the magnet to change a magnetic-field distribution in the partial area; and removing the heat radiation beam to keep the new magnetic domain structure after it is decreased to a normal temperature so that the changed magnetic-field distribution is kept in the partial area, thus forming the printing magnetic orientation master having a predetermined magnetic orientation pattern, and wherein a magnetic field produced by the printing magnetic orientation master is used to magnetically orientate magnetic pigment flakes in a magnetic ink printed on a surface of a substrate of the presswork; and a curing device, being adapted to cure the magnetic ink that has been magnetically orientated on the substrate of the presswork.

The manufacturing apparatus further comprises a transferring device, which is adapted to transfer the substrate of the presswork printed with the magnetic ink to a proper place near the printing magnetic orientation master.

The manufacturing apparatus comprises a roller, wherein at least one said magnetic orientation device is disposed along a circumference of the roller and rotates along with the roller about a central axis of the roller.

During manufacturing of the printing magnetic orientation master, a magnetic field is used to erase the predetermined magnetic orientation pattern of the printing magnetic orientation master to make the printing magnetic orientation master repeatedly rewritable.

During manufacturing of the printing magnetic orientation master, a magnetic field is used to magnetize a magnetizable material layer along a magnetization direction so as to form the magnet.

During manufacturing of the printing magnetic orientation master, the heat radiation beam is a laser beam, an infrared heat radiation beam or an ultrasonic heat radiation beam.

The partial area is heated by the heat radiation beam to a temperature lower than the Curie temperature of the magnet.

The magnet has a planar surface or a cambered surface.

The printing magnetic orientation master has a smooth surface.

To solve the aforesaid technical problem, the present disclosure also provides a manufacturing method for a magnetic pigment presswork, which comprises: using a magnetic field produced by a printing magnetic orientation master to magnetically orientate magnetic pigment flakes in a magnetic ink printed on a surface of a substrate of the presswork; and using a curing device to cure the magnetic ink that has been magnetically orientated on the substrate of the presswork. The printing magnetic orientation master is manufactured by a following method: providing a magnet; using a heat radiation beam to heat a partial area of the magnet so that a new magnetic domain structure is formed in the partial area through self-magnetization of the magnet to change a magnetic-field distribution in the partial area; and removing the heat radiation beam to keep the new magnetic domain structure after it is decreased to a normal temperature so that the changed magnetic-field distribution is kept in the partial area, thus forming the printing magnetic orientation master having a predetermined magnetic orientation pattern.

The manufacturing method for the printing magnetic orientation master further comprises: using a magnetic field to erase the predetermined magnetic orientation pattern of the printing magnetic orientation master to make the printing magnetic orientation master repeatedly rewritable.

The printing magnetic orientation master has a smooth surface.

The present disclosure has the following benefits: as compared with the prior art, the present disclosure uses the thermal disturbance generated by the heat radiation beam in the partial area of the magnet to change the magnetic-field distribution in the partial area, thereby forming the printing magnetic orientation master having the predetermined magnetic orientation pattern. This can simplify the manufacturing process of the printing magnetic orientation master and allow the printing magnetic orientation master to carry abundant pattern information. Furthermore, the magnetic field may be used to erase the predetermined magnetic orientation pattern so that the printing magnetic orientation master produced by this method becomes repeatedly rewritable. Also, during the production process of the printing magnetic orientation master, the magnetic orientation pattern can be immediately erased and then produced again if any mistake happens in the production of the magnetic orientation pattern. Thereby, the processing loss of the production process is nearly zero, thus saving use of the precious permanent-magnetic rare-earth materials. In addition, the printing magnetic orientation master produced through this method may have the smooth surface without any damage caused by etching, so a prolonged service life can be achieved.

### BRIEF DESCRIPTION OF THE DRAWINGS

FIG. 1 is a flowchart diagram of a manufacturing method for a printing magnetic orientation master according to an embodiment of the present disclosure;

FIGS. 2˜4 are schematic views illustrating different steps of the manufacturing method for a printing magnetic orientation master of the present disclosure shown in FIG. 1;

FIGS. 5˜8 are schematic views illustrating different working conditions of a manufacturing apparatus for a magnetic pigment presswork according to a first embodiment of the present disclosure;

FIG. 9 is a schematic structural view of a manufacturing apparatus for a magnetic pigment presswork according to a second embodiment of the present disclosure; and

FIG. 10 is a flowchart diagram of a manufacturing method for a magnetic pigment presswork according to the present disclosure.

### DETAILED DESCRIPTION OF THE INVENTION

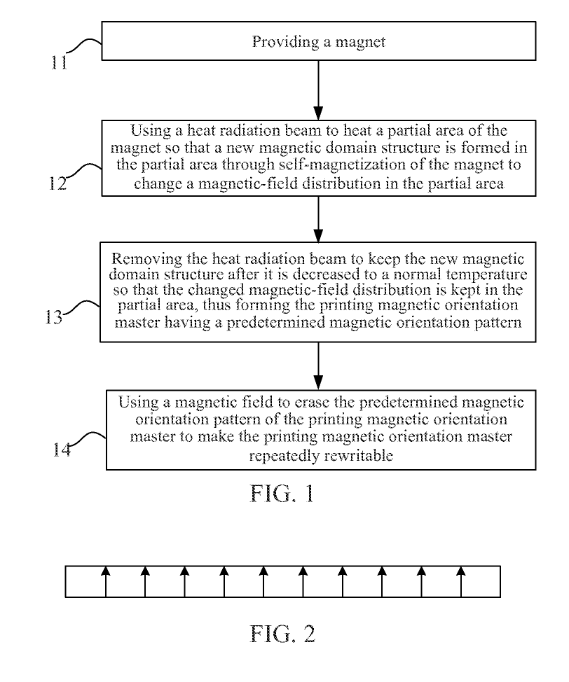

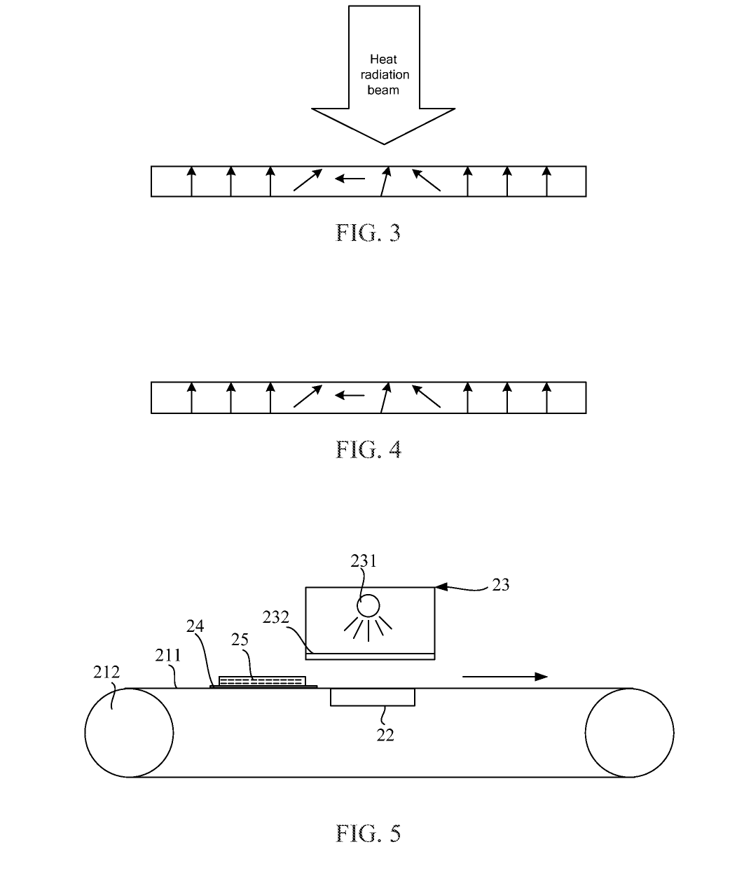

Please refer to FIGS. 1-4. FIG. 1 is a flowchart diagram of a manufacturing method for a printing magnetic orientation master according to an embodiment of the present disclosure; and FIGS. 2˜4 are schematic views illustrating different steps of the manufacturing method for a printing magnetic orientation master of the present disclosure shown in FIG. 1.

In step 11, a magnet is provided.

The magnet in this step has a specific magnetic field direction, which is specifically shown in FIG. 2. This step may comprises: using a magnetic field to magnetize a magnetizable material layer along a magnetization direction so as to form the magnet. The magnet may be a permanent magnet, and may have a smooth surface which may be a planar surface or a cambered surface. The magnetic field for magnetizing a magnetizable material layer may be generated through electromagnetic induction or by a permanent magnet.

In step 12, a heat radiation beam is used to heat a partial area of the magnet so that a new magnetic domain structure is formed in the partial area through self-magnetization of the magnet to change the magnetic-field distribution in the partial area.

The specific process of the step is shown in FIG. 3. The heat radiation beam may be a laser beam, an infrared heat radiation beam or an ultrasonic heat radiation beam. Specifically, when the heat radiation beam is used to heat a partial area of the magnet, the thermal disturbance generated by the heat radiation beam in the partial area will affect the magnetic filed distribution in the partial area so that a new magnetic domain structure is formed in the partial area through self-magnetization of the magnet to generate in the magnet a specific and unduplicatable magnetic orientation pattern that can carry abundant pattern information. Furthermore, after being subjected to the thermal disturbance generated by the heat radiation beam, the surface of the magnet still keeps being smooth and looks unchanged; and the temperature of the partial area heated by the heat radiation beam is not required to reach the Curie temperature of the magnet, and is preferably lower than the Curie temperature of the magnet.

In step 13, a heat radiation beam is used to heat a partial area of the magnet so that a new magnetic domain structure is formed in the partial area through self-magnetization of the magnet to change the magnetic-field distribution in the partial area, the specific process of which is shown in FIG. 3.

In this embodiment, the step of etching the magnet is avoided, so the manufacturing process of the printing magnetic orientation master is simplified. Further, during the manufacturing process of the printing magnetic orientation master, surface features of the magnet remain unchanged so that the printing magnetic orientation master may have a smooth surface, which can greatly reduce the mechanical wear and tear of the magnet that is clamped on the printing equipment and prolong the service life thereof. Also, the magnet may be formed to have a planar or cambered surface to has expand the application scope thereof in printing machineries and to achieve mass industrial production.

As shown in FIG. 2, the manufacturing method of the present disclosure further comprises step 14.

In step 14, a magnetic field is used to erase the predetermined magnetic orientation pattern of the printing magnetic orientation master to make the printing magnetic orientation master repeatedly rewritable. In this embodiment, the magnetic field for erasing the predetermined magnetic orientation pattern may be generated through electromagnetic induction or by a permanent magnet, and the strength of the magnetic field shall be able to change the new magnetic domain structure in the aforesaid partial area so as to achieve the erasing effect.

In this way, the printing magnetic orientation master can be reused. Furthermore, during the production process of the printing magnetic orientation master, the magnetic orientation pattern can be erased immediately and then produced again if any mistake happens in the production of the magnetic orientation pattern. Thereby, the processing loss of the manufacturing process is nearly zero, thus save use of the precious permanent-magnetic rare-earth materials.

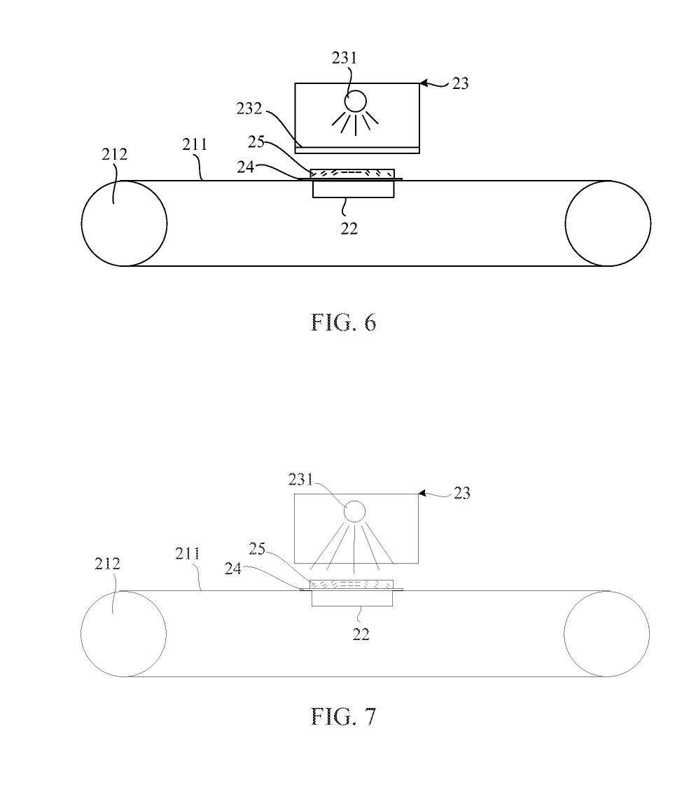

Refer to FIGS. 5˜8, which shows schematic views illustrating different working conditions of a manufacturing apparatus for a magnetic pigment presswork according to a first embodiment of the present disclosure. The manufacturing apparatus for a magnetic pigment presswork of this embodiment is an intermittent printing apparatus. Firstly, a magnetic ink 25 is printed on a surface of a substrate 24 of the presswork in an appropriate manner (e.g., through the silk-screen printing). The magnetic ink 25 comprises magnetic pigment flakes (not shown) that can be magnetically orientated in the magnetic field direction, such as magnetic optically variable pigment flakes. Then, as shown in FIG. 5, the substrate 24 of the presswork printed thereon with the magnetic ink 25 that comprises the magnetic pigment flakes is put on a bearing device 211, and the bearing device 211 is driven by a driving device 212 to transfer the substrate 24 of the presswork to a place above a magnetic orientation device (not shown). The magnetic orientation device comprises a printing magnetic orientation master 22, which is produced through the manufacturing method described in the aforesaid embodiment. In this embodiment, the bearing device 211 is a conveyer belt, and the driving device 212 comprises appropriate components such as a rotating motor and a belt pulley. In other embodiments, the bearing device 211 and the driving device 212 may be replaced by other appropriate transferring devices.

As shown in FIG. 6, after the substrate 24 of the presswork is transferred to a place above the printing magnetic orientation master 22, the driving device 212 stops driving the bearing device 211 so that the substrate 24 of the presswork stays at the place above the printing magnetic orientation master 22. In other embodiments, the bearing device 211 may transfer the substrate 24 of the presswork to other proper places near the printing magnetic orientation master 22 and then stops so that the substrate 24 of the presswork stays there. Then, the magnetic field generated by the printing magnetic orientation master 22 magnetically orientates the magnetic pigment flakes in the magnetic ink 25 to form a predetermined magnetic orientation pattern in the magnetic ink 25.

As shown in FIG. 7, after the magnetic pigment flakes in the magnetic ink 25 is magnetically orientated, a baffle 232 of a curing device 23 is removed so that the curing radiation generated by a radiation curing source 231 of the curing device 23 acts on the magnetic ink 25 to cure the magnetic ink 25 on the substrate 24 of the presswork. In other embodiments, when the radiation curing source 231 can be controlled by a switch via a circuit, the baffle 232 may be omitted.

As shown in FIG. 8, after the magnetic ink 25 is cured on the substrate 24 of the presswork, the baffle 232 of the curing apparatus 23 is closed. Then, the driving device 212 continues to drive the bearing device 211 to move the substrate 24 of the presswork from the place above the printing magnetic orientation master 22 to subsequent work stations so that subsequent operations can be performed.

In FIGS. 5˜8, the printing magnetic orientation master 22 may have a smooth and planar surface, which can facilitate the mass industrial production thereof, reduce the mechanical wear and tear, and prolong the service life thereof.

In FIGS. 5˜8, the magnetic orientation device comprises a printing magnetic orientation master 22. However, in other embodiments, the printing magnetic orientation master 22 may be provided in plural, and the plurality of printing magnetic orientation masters 22 may be arranged in the orientation device in an array, thus forming a plurality of magnetic orientation patterns having a predetermined effect.

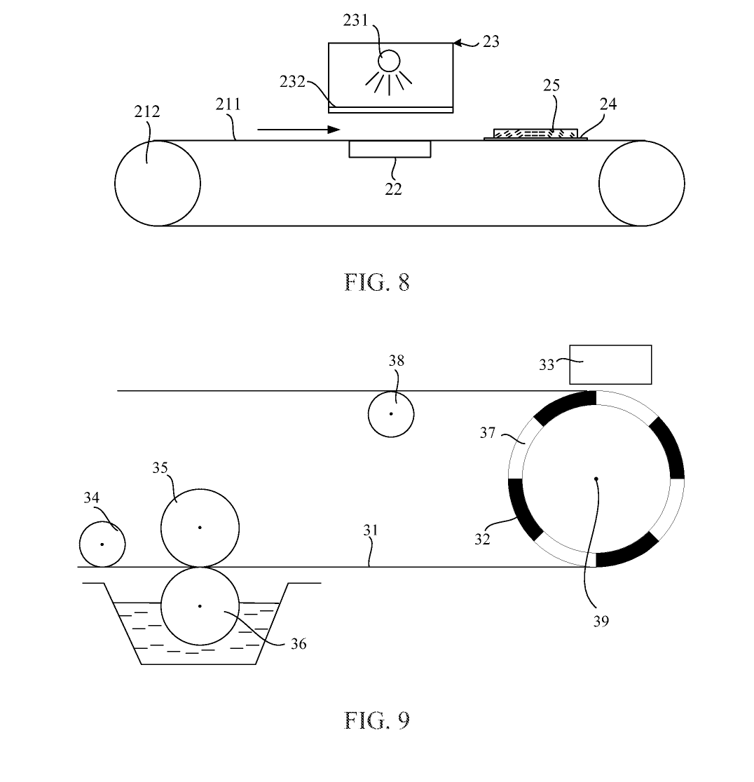

Refer to FIG. 9, which shows a schematic structural view of a manufacturing apparatus for a magnetic pigment presswork according to a second embodiment of the present disclosure. The manufacturing apparatus for a magnetic pigment presswork of this embodiment is a roller continuous printing apparatus. A substrate 31 of the presswork may be transferred in a predetermined direction by tension pulleys 34,38 and a roller 37, which rotate about their respective axes, as well as other transmission devices. The substrate 31 of the presswork may be a piece of paper, a thin film or other flexible materials. A magnetic ink (not shown) is printed by inking rollers 35 and 36 on a surface of the substrate 31 of the presswork. The magnetic ink comprises magnetic pigment flakes (not shown) that can be orientated in the magnetic field direction, such as magnetic optically variable pigment flakes.

The substrate 31 of the presswork that is printed with the magnetic ink on a surface thereof is transferred onto the roller 37. A plurality of magnetic orientation devices (not labeled) are disposed along a circumference of the roller 37. The magnetic orientation apparatus comprises a printing magnetic orientation master 32, which is produced through the manufacturing method described in the aforesaid embodiment. The magnetic orientation devices rotate along with the roller 37 about a central axis 39 of the roller 37, and the magnetic field generated by the rotating printing magnetic orientation master 32 is used to orientate the magnetic pigment flakes in the magnetic ink on the surface of the substrate 31 of the presswork so as to generate magnetic orientation patterns having a predetermined effect in the magnetic ink.

At the same time when the magnetic pigment flakes in the magnetic ink on the surface of the substrate 31 of the presswork are orientated by the printing magnetic orientation master 32, the substrate 31 of the presswork is transferred further to a place below a curing device 33, and the magnetic ink on the surface of the substrate 31 of the presswork is cured by the curing device 33 on the substrate 31 of the presswork. The curing device 33 is a heat radiation beam that can cure the magnetic ink on the substrate 31 of the presswork, e.g., any combination of one or more of a laser beam, an infrared heat radiation beam and an ultrasonic heat radiation beam. In this embodiment, the magnetic orientation devices are preferably inlaid along the circumference of the roller 37 at intervals.

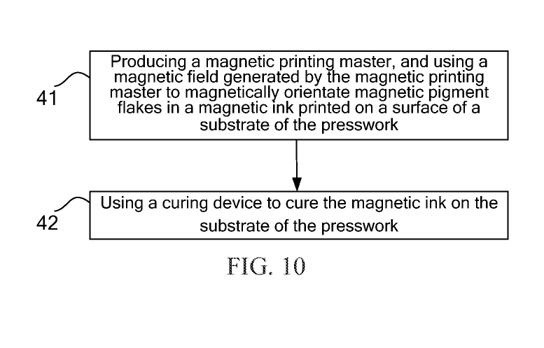

FIG. 10 is a flowchart diagram of a manufacturing method for a magnetic pigment presswork apparatus of the present disclosure.

In step 41, a printing magnetic orientation master is produced through the method described in the aforesaid embodiment, and a magnetic field generated by the printing magnetic orientation master is used to magnetically orientate the magnetic pigment flakes in a magnetic ink printed on a surface of a substrate of the presswork.

In step 42, a curing device is used to cure the magnetic ink on the substrate of the presswork.

The specific implementations to achieve the aforesaid steps 41 and 42 have been detailed above, and thus will not be further described herein.

According to the above descriptions, the present disclosure uses the thermal disturbance generated by the heat radiation beam in the partial area of the magnet to change the magnetic-field distribution in the partial area, thereby forming the printing magnetic orientation master having the predetermined magnetic orientation pattern. This can simplify the manufacturing process of the printing magnetic orientation master and allow the printing magnetic orientation master to carry abundant pattern information. Furthermore, the magnetic field may be used to erase the predetermined magnetic orientation pattern so that the printing magnetic orientation master produced by this method becomes repeatedly rewritable. Also, during the production process of the printing magnetic orientation master, the magnetic orientation pattern can be immediately erased and then produced again if any mistake happens in the production of the magnetic orientation pattern. Thereby, the processing loss of the production process is nearly zero, thus saving use of the precious permanent-magnetic rare-earth materials. In addition, the printing magnetic orientation master produced through this method may have the smooth surface without any damage caused by etching, so a prolonged service life can be achieved.

What described above are only the embodiments of the present disclosure, but are not intended to limit the scope of the present disclosure. Any equivalent structures or equivalent process flow modifications that are made according to the specification and the attached drawings of the present disclosure, or any direct or indirect applications of the present disclosure in other related technical fields shall all be covered within the scope of the present disclosure.

1. A manufacturing method for a printing magnetic orientation master, comprising:
providing a magnet;
using a heat radiation beam to heat a partial area of the magnet so that a new magnetic domain structure is formed in the partial area through self-magnetization of the magnet to change a magnetic-field distribution in the partial area; and
removing the heat radiation beam to keep the new magnetic domain structure after it is decreased to a normal temperature so that the changed magnetic-field distribution is kept in the partial area, thus forming the printing magnetic orientation master having a predetermined magnetic orientation pattern.

2. The manufacturing method of claim 1, further comprising:
using a magnetic field to erase the predetermined magnetic orientation pattern of the printing magnetic orientation master to make the printing magnetic orientation master repeatedly rewritable.

3. The manufacturing method of claim 2, wherein the magnetic field is generated through electromagnetic induction or by a permanent magnet.

4. The manufacturing method of claim 1, wherein the step of providing a magnet comprises: using a magnetic field to magnetize a magnetizable material layer along a magnetization direction so as to form the magnet.

5. The manufacturing method of claim 1, wherein the heat radiation beam is a laser beam, an infrared heat radiation beam or an ultrasonic heat radiation beam.

6. The manufacturing method of claim 1, wherein the partial area is heated by the heat radiation beam to a temperature lower than the Curie temperature of the magnet.

7. The manufacturing method of claim 1, wherein the magnet has a planar surface or a cambered surface.

8. The manufacturing method of claim 1, wherein the printing magnetic orientation master has a smooth surface.

9. A manufacturing apparatus for a magnetic pigment presswork, comprising:
a magnetic orientation device, comprising a printing magnetic orientation master, wherein the printing magnetic orientation master is manufactured by a following method: providing a magnet; using a heat radiation beam to heat a partial area of the magnet so that a new magnetic domain structure is formed in the partial area through self-magnetization of the magnet to change a magnetic-field distribution in the partial area; and removing the heat radiation beam to keep the new magnetic domain structure after it is decreased to a normal temperature so that the changed magnetic-field distribution is kept in the partial area, thus forming the printing magnetic orientation master having a predetermined magnetic orientation pattern; and wherein a magnetic field produced by the printing magnetic orientation master is used to magnetically orientate magnetic pigment flakes in a magnetic ink printed on a surface of a substrate of the presswork; and
a curing device, being adapted to cure the magnetic ink that has been magnetically orientated on the substrate of the presswork.

10. The manufacturing apparatus of claim 9, further comprising a transferring device, which is adapted to transfer the substrate of the presswork printed with the magnetic ink to a proper place near the printing magnetic orientation master.

11. The manufacturing apparatus of claim 9, further comprising a roller, wherein at least one said magnetic orientation device is disposed along a circumference of the roller and rotates along with the roller about a central axis of the roller.

12. The manufacturing apparatus of claim 9, wherein during manufacturing of the printing magnetic orientation master, a magnetic field is used to erase the predetermined magnetic orientation pattern of the printing magnetic orientation master to make the printing magnetic orientation master repeatedly rewritable.

13. The manufacturing apparatus of claim 9, wherein during manufacturing of the printing magnetic orientation master, a magnetic field is used to magnetize a magnetizable material layer along a magnetization direction so as to form the magnet.

14. The manufacturing apparatus of claim 9, wherein during manufacturing of the printing magnetic orientation master, the heat radiation beam is a laser beam, an infrared heat radiation beam or an ultrasonic heat radiation beam.

15. The manufacturing apparatus of claim 9, wherein the partial area is heated by the heat radiation beam to a temperature lower than the Curie temperature of the magnet.

16. The manufacturing apparatus of claim 9, wherein the magnet has a planar surface or a cambered surface.

17. The manufacturing apparatus of claim 9, wherein the printing magnetic orientation master has a smooth surface.

18. A manufacturing method for a magnetic pigment presswork, comprising:
using a magnetic field produced by a printing magnetic orientation master to magnetically orientate magnetic pigment flakes in a magnetic ink printed on a surface of a substrate of the presswork; and
using a curing device to cure the magnetic ink that has been magnetically orientated on the substrate of the presswork;
wherein the printing magnetic orientation master is manufactured by a following method: providing a magnet;
using a heat radiation beam to heat a partial area of the magnet so that a new magnetic domain structure is formed in the partial area through self-magnetization of the magnet to change a magnetic-field distribution in the partial area; and
removing the heat radiation beam to keep the new magnetic domain structure after it is decreased to a normal temperature so that the changed magnetic-field distribution is kept in the partial area, thus forming the printing magnetic orientation master having a predetermined magnetic orientation pattern.

19. The manufacturing method for a magnetic pigment presswork of claim 18, wherein the manufacturing method for the printing magnetic orientation master further comprises: using a magnetic field to erase the predetermined magnetic orientation pattern of the printing magnetic orientation master to make the printing magnetic orientation master repeatedly rewritable.

20. The manufacturing method for a magnetic pigment presswork of claim 18, wherein the printing magnetic orientation master has a smooth surface.
